(19) United States
(12) Patent Application Publication
(10) Pub. No.: US 2009/0109590 A1
(43) Pub. Date: Apr. 30, 2009

(54) Self-protected solid-state electrical switching device

(75) Inventors: Dominique Girot, Clerieux (FR); Herve Carton, Livron (FR)

Correspondence Address: STEPTOE & JOHNSON LLP, 1330 CONNECTICUT AVENUE, N.W., WASHINGTON, DC, 20036, US

(73) Assignee: CROUZET AUTOMATISMES, Valence (FR)

(21) Appl. No.: 12/285,330

(22) Filed: Oct. 2, 2008

(30) Foreign Application Priority Data
Oct. 26, 2007 (FR) 07 07548

(51) Int. Cl. H02H 3/08; H02H 5/04

(52) U.S. Cl. 361/93.8; 361/93.1

(57) ABSTRACT

A self-protected solid-state switching device comprising first opening means connected in series with a first fuse link, means for measuring electric current and control means acting on opening and closing of said first opening means according to the value of a main electric current flowing through said switching device. Said device comprises at least a second fuse link connected in parallel with the first fuse link, at least second electric opening means being connected in series

### BACKGROUND OF THE INVENTION

The invention relates to a self-protected solid-state switching device comprising first opening means connected in series with a first fuse link, means for measuring electric current and control means acting on opening and closing of said first opening means according to the value of a main electric current (i) flowing in said switching device.

### STATE OF THE ART

Power components used to perform the electrical switching function are widely used in particular in the aeronautics field. These components can for example be MOSFET, IGBT, BIPOLAR or ESBT® transistors. Switching devices used as solid-state circuit breaker are hereafter called SSPC (Solid State Power Controler) or SSTC (Solid State Tripping Contactor).

The main reason for malfunctioning of SSPC switching means arises from the fact that they may be in a short-circuit state after they have been destroyed. Each power commutator switch, although it is protected against the causes of destruction due to overheating, overvoltage or abrupt voltage variations, can however be greatly damaged and place itself in a short-circuit state.

Since the use of SSPC was generalized in civil aviation jumbo jets, the certification authorities have stipulated that SSPCs must integrate a second protection level. To make the installation secure in the case of an SSPC power commutator switch being damaged, it is in fact provided to insert a second circuit opening device. This second opening device is placed in series with the SSPC power commutator switch. This second opening device will open in case of an electric over-consumption, in particular in case of a short-circuit. The assembly formed by the power commutator switch and the second opening device is thereby self-protected. This self-protection is henceforth referred to as “fail-safe”.

As represented in FIG. 1, it is known to use a fuse 3 as second opening device. The fuse 3 is placed in series with the power commutator switch 3 of the SSPC 1. However, the use of a fuse 3 is not always judicious because of a too large relative uncertainty as to the rated current value of said fuse. Fuse 3 theoretically reaches its melting threshold when it has electric currents having higher current intensity values than the rated intensity value flowing through it. What is meant by rated intensity value is the value supplied by the fuse manufacturer. In reality, the melting threshold can be reached for slightly higher or slightly lower electric current values.

On account of the dispersion of the characteristics of a fuse around its rated intensity value, two melting curves can be established. A first curve, called min, represents melting of the fuse for the lowest current values. A second curve, called max, represents melting of the fuse for the highest current values.

As represented schematically in FIG. 2, curve A represents the opening time of a power commutator switch versus an electric current flowing through the latter. According to this embodiment, the SSPC is designed to protect a cable against currents with an intensity of more than five amps. For example, the cable comprises the following reference: Gauge AWG 24. Curve B represents the smoke curve of said cable. Curves F1 represent the min and max melting curves of a protective fuse of 10 amp rating placed in series with the SSPC power commutator switch.

In normal operation, the SSPC has to be able to be reset after it has tripped and the fuse must preferably not melt before the SSPC power commutator opens. Furthermore, to ensure that the fuse does not melt after the cable, the max melting curve has to be chosen so as to be below the smoke curve of the cable.

On account of the dispersion of the characteristics of the fuse, it is very difficult to obtain a fuse complying with these two operating conditions. A first operating condition consists in using a fuse having a max melting curve that is lower than the smoke curve of the cable. The second operating condition consists in using a fuse having a min melting curve that is not lower than the tripping curve of the SSPC power commutator switch.

If the second operating condition is not complied with, the fuse is liable to melt before the SSPC trips. Under these circumstances, changing of the second opening device, in other words the fuse, results in airplanes being immobilized. These immobilizations could have been avoided if the circuit breaker function had operated before the fuse. Simple remote resetting of the SSPC after the fault had been cleared would in fact have been sufficient.

### SUMMARY OF THE INVENTION

The object of the invention is to remedy the shortcomings of the state of the technique so as to propose a fail-safe solid-state switching device having a dependable operation.

The fail-safe solid-state switching device according to the invention comprises at least a second fuse link connected in parallel with the first fuse link, at least second electric opening means being connected in series with said at least a second fuse link.

According to a preferred embodiment of the invention, said at least second opening means connected to said at least a second fuse link are connected in parallel with the first fuse link.

According to another preferred embodiment of the invention, said at least second opening means connected to said at least a second fuse link are connected in parallel with the first fuse link and with the first opening means.

Advantageously, the first electric opening means is a power commutator switch connected to the opening and closing control means.

Advantageously, said at least second electric opening means is a power commutator switch connected to the opening and closing control means.

Preferably, said at least second electric opening means comprise an electromagnetic relay.

According to a particular embodiment, the electromagnetic relay is controlled by a bimetal strip.

Preferably, the main electric current flows through the bimetal strip which is calibrated to deform and actuate the relay when the main current is higher than a first threshold.

Preferably, a secondary electric current flowing through said at least a second fuse link flows through the bimetal strip which is calibrated to deform and actuate the relay when the secondary current is higher than a second threshold.

Preferably, all the fuse links have substantially identical rated intensity values.

### BRIEF DESCRIPTION OF THE DRAWINGS

Other advantages and features will become more clearly apparent from the following description of particular embodiments of the invention given for non-restrictive example purposes only and represented in the accompanying drawings.

FIG. 1 represents a schematic view of a fail-safe solid-state switching device according to a known embodiment;

FIG. 2 represents a plot of the opening time of a power commutator switch of a fail-safe solid-state switching device versus an electric current flowing through the latter according to an embodiment represented in FIG. 1;

FIG. 3 represents a schematic view of a fail-safe solid-state switching device according to a first preferred embodiment of the invention;

FIG. 4 represents a schematic view of a fail-safe solid-state switching device according to a second preferred embodiment of the invention;

FIG. 5 represents a plot of the opening time of a commutator switch according to the embodiments represented in FIGS. 3 and 4 in normal operating mode;

FIG. 6 represents a plot of the opening time of a commutator switch according to the embodiments represented in FIGS. 3 and 4 in the presence of an operating fault.

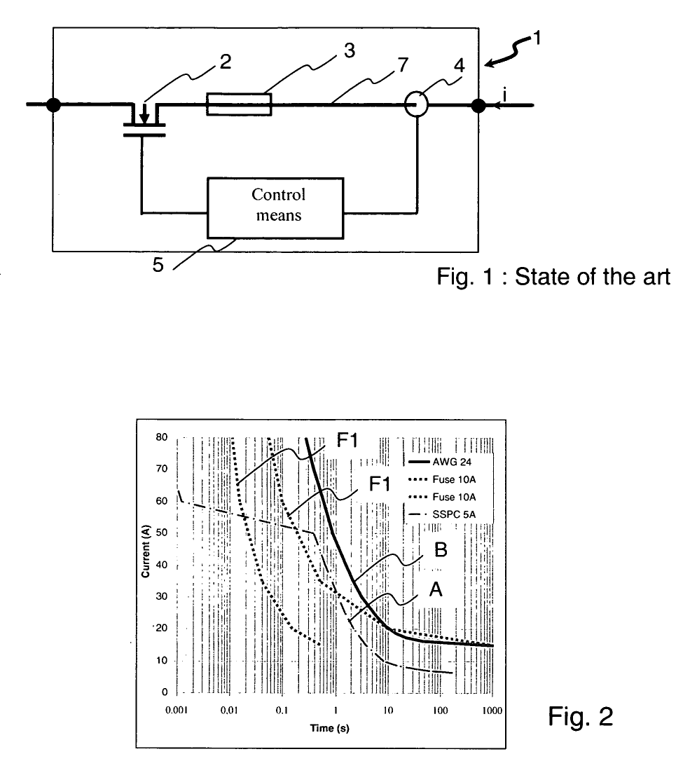

### DETAILED DESCRIPTION OF AN EMBODIMENT

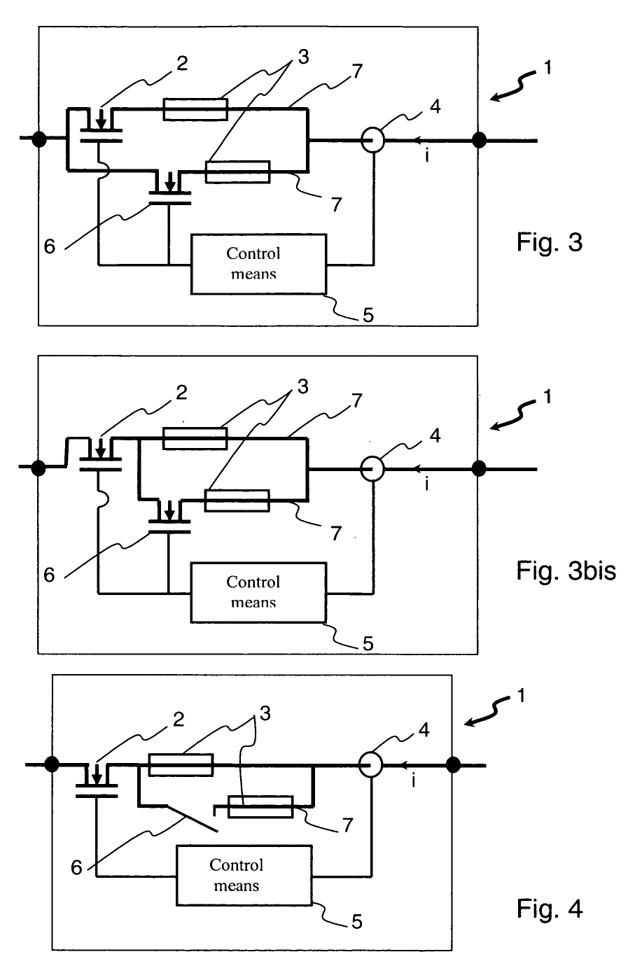

According to a first preferred embodiment of the invention represented in FIG. 3, the fail-safe solid-state switching device I comprises at least two branches 7 placed in parallel. Each branch 7 comprises at least a power commutator switch 2 connected in series with a fuse 3.

The fail-safe solid-state switching device I comprises a current sensor 4 measuring the electric current i flowing through said device. Said current will be called main current i in the following. Current sensor 4 is connected to control means 5. Said control means are connected to power commutator switches 2 to command opening and closing thereof. The electric current i flowing in the fail-safe solid-state switching device I divides in each branch 7 of the circuit. The electric currents flowing in the different branches 7 of the circuit will be called secondary current i/n in the following.

The secondary currents flowing in branches 7 of the circuit are of the same intensity. A secondary electric current i/n having a value equal to the value of the main electric current 1 divided by n then flows in each fuse 3, n being equal to the number of branches 7. According to the embodiments represented in FIGS. 3 and 4, the number of branches 7 is equal to two (n=2). The secondary currents flowing in the branches 7 are equal and have the value i/2.

The fuses 3 preferably have substantially identical rated intensity values.

Operation of the fail-safe solid-state switching device I according to the first embodiment is as follows.

The rated intensity values of each fuse 3 are chosen according to the maximum permissible secondary current in each branch 7. According to the first preferred embodiment, the maximum permissible secondary current is equal to the value of the maximum permissible main current divided by the number of branches 7. The value of the maximum permissible main current is dependent on the cable that has to be protected.

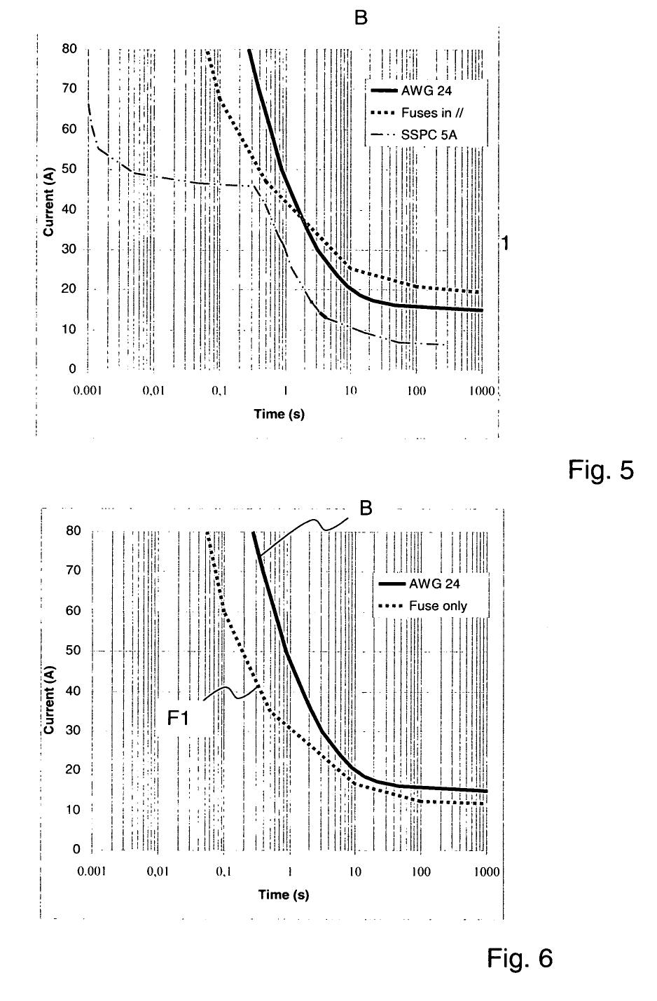

When all the commutator switches are operating normally, each power commutator switch 2 placed in series with one of the fuses 3 opens when the main current i measured by the current sensors 4 is greater than the maximum permissible main current. Breaking is then performed correctly by the fail-safe solid-state switching device 1. As represented in FIG. 5, curve plot A represents the opening time of the power commutator switches 2 versus the electric current. Said plot is located before curve plot F1 representative of plotting of melting of the protective fuses 3 placed on the branches 7 and the smoke curve B of the cable to be protected. Curve plot F1 is a resulting plot representative of the sum of the min melting curves of the fuses 3 fitted in parallel. This configuration guarantees that the fuses 3 do not reach their melting threshold before the power commutator switches 2 open.

When one of the power commutator switches 2 is damaged and places itself in short-circuit state, the secondary electric current i/n flowing in the branch or branches 7 that are not open is then greater than the maximum permissible secondary current in each branch 7.

According to the embodiment represented in FIG. 3, the secondary electric current flowing in branch 7 comprising the short-circuited power commutator switch 2 is substantially equal to the maximum permissible main current. An electric current considerably higher than the maximum permissible secondary current then flows in the fuse 3 placed in series with the short-circuited power commutator switch 2. The melting threshold is reached and said fuse melts. Breaking is then performed correctly by the fail-safe solid-state switching device 1. As represented in FIG. 5, curve plot F1 represents the max melting curve of the protective fuse 3 placed on the branch 7 that still has an electric current flowing through it following sending of the opening order of control means 5. Said curve plot is located before curve plot B representative of the smoke curve of the cable to be protected. This configuration guarantees that the fuse 3 reaches its melting threshold before the cable to be protected is damaged.

Moreover, the fail-safe solid-state switching device I is definitively open. Indeed, if control means 5 send a closing order to the power commutator switches 2 although the operating fault has not been solved, the secondary electric current flowing in the branches 7 would necessarily be of higher intensity than the maximum permissible secondary current in each branch, since one of the branches 7 has been definitively opened by its fuse 3, and would result in melting of the remaining fuse or fuses 3.

According to an alternative embodiment of the first preferred embodiment mode, the fail-safe solid-state switching device I comprises three fuses. Each of the fuses is placed on a branch 7 of the circuit.

According to a second preferred embodiment of the invention represented in FIG. 4, a second opening means 6 is connected in series with a fuse 3 of one of the branches 7. According to this embodiment mode, the fail-safe solid-state switching device 1 comprises two branches 7 connected in parallel. Each branch respectively comprises a fuse 3 placed in series with a power commutator switch 2.

The secondary currents flowing in the branches 7 of the circuit are of the same intensity. Each fuse then has a secondary electric current i/n flowing through it having a value equal to the value of the main electric current i divided by n, n being equal to the number of branches 7.

According to the embodiment presented in FIG. 4, the secondary currents flowing in the branches 7 have the value i/2. Each fuse 3 is then calibrated to reach its melting threshold for secondary electric currents of a value equal to half the maximum permissible main current. The value of the maximum permissible main current is dependent on the cable that has to be protected. The second opening means 6 is in series with one of the two fuses 3. The second opening means 6 is designed to open when the electric current flowing through the fail-safe solid-state switching device I is greater than the maximum permissible main current.

Operation of the fail-safe solid-state switching device I according to the first preferred embodiment is as follows.

When the power commutator switch 2 is operating normally, the latter opens when the main current measured by the current sensors 4 is greater than the maximum permissible main current. Breaking is then performed correctly by the fail-safe solid-state switching device 1.

When the commutator switch 2 is damaged and places itself in a short-circuit state, the secondary electric currents flowing in the branches 7 of the circuit are then greater than the maximum permissible secondary current in each branch 7. The second opening means 6 open on account of the fact that the current flowing in the fail-safe solid-state switching device 1 is greater than the maximum permissible main current, and the second commutator switch 2 can no longer open.

After opening of the second opening means 6, the electric current flows in the other branch or branches 7. According to the embodiment represented in FIG. 4, the electric current flows in the second branch 7 and causes melting of the fuse present on this branch 7. An electric current of a value equal to the value of the main current is in fact flowing through said fuse.

In this way, even if the second opening means 6 present on the first branch 7 recloses, the electric current causes melting of the fuse present on the first branch. The fail-safe solid-state switching device 1 is henceforth definitively open. This situation could occur according to a particular embodiment of passive type.

The fuses 3 preferably have substantially identical rated intensity values.

The second opening means 6 can be passive or of autonomous control type. When the second opening means 6 is a bimetal strip, the system is entirely passive, but is not very precise.

When the second opening means 6 are formed by a relay controlled by a software program controlling the fail-safe solid-state switching device 1, the system is active and precise. However, this protection means must have its own electric power supply. Furthermore, in order to be autonomous, its decision logic has to be different from that of the control means 5. The second opening means 6 can also be a relay controlled by a function of I2t type, independent from the SSPC function. It is then an active, precise and autonomous system.

1. A fail-safe solid-state switching device comprising first opening means connected in series with a first fuse link, means for measuring electric current and control means acting on opening and closing of said first opening means according to the value of a main electric current flowing in said switching device, a device comprising at least a second fuse link connected in parallel with the first fuse link, at least second electric opening means being connected in series with said at least a second fuse link.

2. The fail-safe solid-state switching device according to claim 1, wherein said at least second opening means connected to said at least a second fuse link are connected in parallel with the first fuse link.

3. The fail-safe solid-state switching device according to claim 2, wherein said at least second opening means connected to said at least a second fuse link are connected in parallel with the first fuse link and with the first opening means.

4. The fail-safe solid-state switching device according to claim 1, wherein the first electric opening means is a power commutator switch connected to the opening and closing control means.

5. The fail-safe solid-state switching device according to claim 1, wherein said at least second electric opening means is a power commutator switch connected to the opening and closing control means.

6. The fail-safe solid-state switching device according to claim 1, wherein said at least second electric opening means comprises an electromagnetic relay controlled by a bimetal strip.

7. The fail-safe solid-state switching device according to claim 6, wherein the electromagnetic relay is controlled by a bimetal strip.

8. The fail-safe solid-state switching device according to claim 7, wherein the main electric current flows through the bimetal strip which is calibrated to deform and actuate the relay when the main current is higher than a first threshold.

9. The fail-safe solid-state switching device according to claim 7, wherein a secondary electric current flowing through said at least a second fuse link flows through the bimetal strip which is calibrated to deform and actuate the relay when the secondary current is higher than a second threshold.

10. The fail-safe solid-state switching device according to claim 1, wherein all the fuse links have substantially identical rated intensity values.
